(19) United States
(12) Patent Application Publication
(10) Pub. No.: US 2008/0313060 A1
(43) Pub. Date: Dec. 18, 2008

(54) OPENLY ACCESSIBLE INVENTORY MANAGEMENT SYSTEM AND METHOD

(76) Inventor: Suresh K. Damodaran, Acton, MA (US)

Correspondence Address: RAMAN N. DEWAN;JACKSON WALKER, L.L.P., 100 CONGRESS AVENUE, SUITE 1100, AUSTIN, TX, 78701, US

(21) Appl. No.: 11/764,655

(22) Filed: Jun. 18, 2007

(51) Int. Cl. G06Q 10/00

(52) U.S. Cl. 705/28

(57) ABSTRACT

A system enabling users to view and initiate action to alter the geographic distribution of the pooled inventory of an item includes an inventory registry, a transaction module, and a viewing module. The inventory registry includes information indicative of a pooled inventory of an item including inventory from two or more suppliers of the item. In some embodiments, the registry is openly accessible to multiple suppliers and multiple consumers of the item. The transaction module enables a remote user to execute an inventory transaction to alter the pooled inventory distribution indicated in the inventory registry. The viewing module accesses the inventory registry and produces information enabling a user to visualize the inventory distribution. The inventory management system may interface with value added service including as examples, an auction/bidding module, a price negotiation module, and a cost estimation module.

### FIELD OF THE DISCLOSURE

The present disclosure is in the field of inventory management.

### BACKGROUND OF THE DISCLOSURE

Inventory management systems enable an entity to monitor its inventory and react to inventory changes. Inventory management can be especially challenging in the context of an emergency, natural disaster, or any other condition that produces sudden, dramatic, and often localized disparities in the supply and demand of goods.

### BRIEF DESCRIPTION OF THE DRAWINGS

FIG. 1 is a block diagram illustrating an embodiment of an inventory management system or network;

FIG. 2 is a conceptual diagram illustrating an embodiment of an inventory registry;

FIG. 3 is a flow diagram illustrating exemplary functionality for an embodiment of a transaction module;

FIG. 4 is a flow diagram illustrating exemplary functionality for an embodiment of a viewing module;

FIG. 5 is a flow diagram illustrating exemplary functionality for an embodiment of a bidding module;

FIG. 6 is a flow diagram illustrating an embodiment of a service for enabling a data processing system with inventory management functionality; and

FIG. 7 is a diagram of an embodiment of a general computer system.

### DETAILED DESCRIPTION OF THE DRAWINGS

Disclosed is a system enabling users to view and initiate action to alter the geographic distribution of or otherwise affect the pooled inventory of a good, product, or other item of inventory. The system is suitable, as an example, for discovering and moving scarce inventory to ease critical shortages of specific items at specific locations. In this context, the items of inventory may be pharmaceutical products, bottled water, non perishable food items, and so forth. The disclosed system is suitable for addressing inventory imbalances following natural disasters, emergency conditions, or simply due to unavailability of items due to high demand at specific stores.

In one aspect, an inventory manager is disclosed. The inventory manager may be implemented as an integrated or distributed system that includes at least one processor, one or more network interfaces, and one or more storage resources. The processors have access to network interfaces enabling them to communicate via one or more networks. The storage resources are accessible to the processors may include persistent storage devices or other forms of computer readable medium in or on which data, data structures, and/or software modules are stored.

The storage resource(s) contain one more data structures and software modules including an inventory registry, a transaction module, and a viewing module. These elements may integrated within a single physical system or distributed across two or more distinct systems. In the distributed implementation, the elements may exist on systems that are widely dispersed geographically and connected via a network. The system may include redundant or proxy instances of one or more of the elements, and these redundant or proxy instances may, themselves be distributed across disparate systems.

The inventory registry includes information indicative of a pooled inventory of an item including inventory from two or more suppliers of the item. In some embodiments, the registry is openly accessible to multiple suppliers and multiple consumers of the item. The transaction module enables a remote user to execute an inventory transaction to alter the pooled inventory distribution indicated in the inventory registry. The viewing module accesses the inventory registry and produces information enabling a user to visualize the inventory distribution. The inventory management system may interface with value added service including as examples, an auction/bidding module, a price negotiation module, and a cost estimation module.

In some embodiments, the inventory registry is openly available via the network and, as such, is accessible to a plurality of remotely located suppliers, including competing suppliers, of the item and to a plurality of remotely located consumers of the item. The inventory registry may include or support a standardized identification of the item to ensure uniqueness and consistency of product identifiers. Exemplary identifiers might be based on a global trade identifier number (GTIN) as specified by the GS1. The inventory registry may also include or support a standardized identification of the supplier or other user. A supplier or consumer might, for example, uniquely identify itself with a GS1 Global Location Number (GLN). GS1 is a global organization dedicated to the design and implementation of global standards and solutions to improve the efficiency and visibility of supply and demand chains globally and across multiple sectors.

In some embodiments, the inventory registry includes separate entries for inventory of the item located at two different physical locations, i.e., a first entry for inventory located at a first location and a second entry for inventory stored at a second location.

The transaction module is preferably responsible for updating the contents of the inventory registry to reflect changes in inventory distribution caused by inventory consuming transactions inventory generating transactions. The transaction module preferably detects a request to access the inventory registry and, in response, determines whether the request is from a supplier or a consumer of the item. In some embodiments, the viewing module produces information enabling the user to visualize the inventory distribution via a plurality of quantity indicators superimposed on a map encompassing at least location in the geographic distribution.

In one aspect, a computer implemented inventory manager is disclosed as including an inventory registry, a viewing module, and a transaction module. The inventory register represents or contains information indicative of a pooled inventory of an item where the pooled inventory includes inventory of the item from supplied by two or more suppliers. The item may be a critical item such as medicine, bottled water, or a food staple. In at least some embodiments, the registry is openly accessible to multiple suppliers of the item and to multiple consumers of the item. The viewing module accesses the inventory registry and produces information indicative of or otherwise representing the pooled inventory. The transaction module enables a remote user to execute an inventory transaction to alter the pooled inventory indicated in the inventory registry.

The inventory registry information may include a standardized identification of each item, for example, a global trade identification number (GTIN). The pooled inventory may be suitable to convey a geographic distribution of the pooled inventory. In some implementations, the item is in critical shortage at a first geographic location and the pooled inventory reflects inventory of the item at a second geographic location. In this context, the transaction module may enable a consumer to initiate movement of at least some of the inventory at the second geographic location to the first geographic location.

In another aspect, a computer program product is disclosed as having computer executable instructions, stored on a computer readable medium, where the instructions can cause a computer implemented inventory manager to detect a user request to access an inventory registry. The inventory register contains information indicative of an item's pooled inventory. The pooled inventory encompasses inventory of the item from two or more suppliers. In some embodiments, the inventory registry information also indicates a geographic distribution of the pooled inventory. The program product further include a viewing module and a transaction module. The viewing module includes instructions to respond to the user request by providing information enabling the user to visualize the geographic distribution of the pooled inventory. The transaction module includes instructions to enable the user to define and execute an inventory transaction that alters the geographic distribution of the pooled inventory, such as by enabling a consumer to initiate movement of at least some of the inventory located at the second geographic location to a first geographic location where there may be a sudden and/or sever shortage of the item. The transaction module may also include instructions to invoke one or more value added services that address the cost of the transaction. For example, the value added services may include a logistics estimator enabling the user to shipping cost estimates from one or more carriers.

In still another aspect, a disclosed A inventory management method includes provisioning a system with a database structure, a viewing module, and a transaction module. The database structure may be an inventory registry that represents the pooled inventory of an item where the pooled inventory reflects inventory from multiple suppliers of the item and conveys a geographic distribution of the pooled inventory. The viewing module interacts with a user's web browser and/or application specific client to enable the user to visualize the pooled inventory's geographic distribution in a graphical or textual format. The transaction module enables the user to define and execute an inventory transacation that alters the geographic distribution of the pooled inventory by moving a portion of the pooled inventory to a first geopgrahic location from a second geographic location. The transacation module updates the inventory registry to reflect the alteration. The inventory registry may include multiple entries, where each entry represents a portion of the pooled inventory. Each entry may contain a GTIN or other standardized identifier of the item, an identification of the supplier of the corresponding pooled inventory portion, a quantity indication, and an indication of the geographic location of the corresponding pooled inventory potion. In some embodiments, the transaction module enables a user to define a single transaction to transfer inventory located at a first geographic location to a second geographic location without regard to the identity or number of suppliers of the inventory at the first geographic location. Some embodiments of the method support or require user registration as part of being able to access the inventory registry. Registration may include selective registration in which access to the registry is filtered according to one or more parameters. For example, in a situation where a first geographic location is experiencing a shortage of the item supplier access to the inventory registry may be limited to suppliers that are able to provide inventory to the first location and to consumers located at the first geographic location.

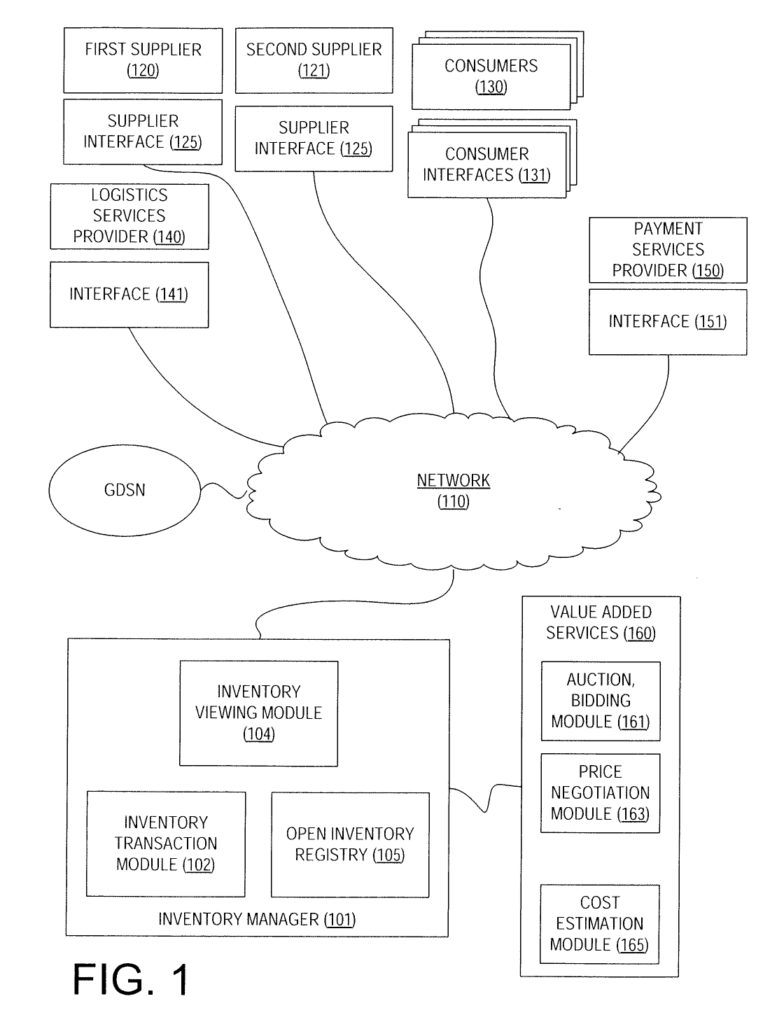

Referring to FIG. 1, selected elements of a system 100 emphasizing an inventory manager (IM) 101 are disclosed. As depicted in FIG. 1, system 100 is a distributed system that includes various elements interconnected via a network 110. In other embodiments, any two or more of the distributed elements shown in FIG. 1 may be integrated within a single system. In the depicted embodiment, network 110 encompasses both local and wide area networks and supporting network appliances and other devices. Thus, for example, network 110 may include elements of a conventional Ethernet local area network (LAN) as well as elements of a wide area network such as the Internet.

System 100 is illustrated in the depicted embodiment as including, in addition to the inventory manager 101, multiple suppliers including a first supplier 120 and a second supplier 121, multiple consumers 130, logistics service provider(s) 140, and payment services providers 150. Consumers 130 are shown as being connected to network 110 via consumer interfaces 131. First supplier 120 is shown as being in communication with network 110 via a first supplier interface 125 and Second supplier 121 is shown as being in communication with network 110 via a second supplier interface 126, which may be the same or substantially similar to first supplier interface 125. Similarly, logistics service provider 140 communicates with inventory manager 101 via a logistics interface 141 and payment service provider(s) 150 communicate with inventory manager 101 via payment provider interface 151. In some embodiments, interfaces 125, 126, 131, 141, and 151 represent and/or include conventional web browsers. In other embodiments, however, interfaces 125, 126, 131, 141, and 151 may include application specific or special purpose interfaces designed or otherwise optimized to facilitate communication between the various users of inventory manager 101.

Suppliers 120 and 121 encompass any entity that provides goods to another. Suppliers 120 and 121 could be, for example, manufacturers and wholesalersg of goods as well as retailers and other downstream providers of goods. Consumers 130 encompass individuals as well as groups of individuals and/or corporate or governmental entities that purchase or otherwise acquire goods. Thus, for example, system 100 includes implementations in which suppliers 120 and 121 are retailers and consumers 130 is an individual consumers. System 100 also includes implementations in which, for example, suppliers 120 and 121 are wholesalers or manufacturers of goods and consumers 130 include a retail store acquiring goods from its supplier.

Inventory manager 101 includes functionality enabling multiple suppliers 125 and 126 and multiple consumers 130 to monitor and alter the inventory and, more particularly, the pooled inventory of a particular item. The pooled inventory of an item is a cumulative inventory that encompasses the inventories of multiple and potentially competing suppliers of the product. In the implementation depicted in FIG. 1, inventory manager 101 includes a database structure referred to as the open inventory registry (IR) 105, an inventory transaction module (TM) 102, and an inventory viewing module (VM) 104. Additional functionality is shown as being made available to inventory manager 101 via valued added services 160 that may include, as shown, an auction/bidding module 161, a price negotiation module 163, and a cost estimate module (165). It should be emphasized that, although FIG. 1 depicts inventory manager 101 as a single block, this representation does not restrict implementations of inventory manager 101 to single system or integrated implementations. In some implementations, one or more of the elements of inventory manager 101 are distributed across multiple servers or other systems, some or all of which may be dispersed over large geographic areas.

IR 105 is a database structure that includes information indicative of an item's pooled inventory. IR 105 includes quantity and geographic location information for multiple suppliers of the item so that IR 105 contains information that conveys the geographic distribution of the item's pooled inventory. In embodiments suitable for use with applications that include the redistribution of scare inventory following a natural disaster, for example, IR 105 may be implemented as an openly accessible database structure that reflects the pooled inventory of critical items including, as examples, medicine, food staples, and bottled water. IR 105 may also contain information that conveys the geographic distribution of the pooled inventory of an item. For example, where a shortage of an item is occurring at a first geographic location, such as the site of an emergency or disaster, IR 105 may contain information conveying the pooled inventory of an item at a second geographic location that is removed from the first geographic location.

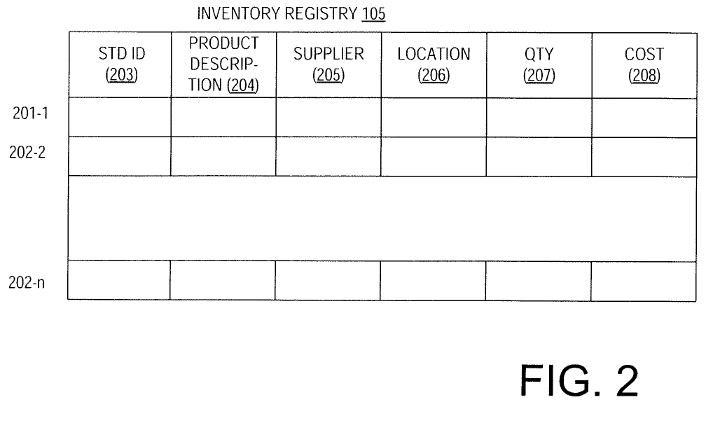

An embodiment of IR 105 is illustrated in FIG. 2 as a data table 201 that includes a plurality of entries 202-1 through 202-n, generically or collectively referred to herein as entry/entries 202. Each entry 202 in data table 201 as shown includes information including a unique and standardized identifier 203, a textual or graphical description (204) of the product, a unique and standardized or recognized indication (205) of the supplier, an indication (206) of the address or geographic location of the inventory corresponding to the entry, an indication (207) of the quantity of inventory, and in the depicted embodiment, an indication (208) of a cost associated with the inventory corresponding to the entry.

The standardized number 203 may be implemented with a global trade identification number (GTIN). A GTIN is an identifier for trade items developed by GS1. GTIN encompasses all of the GS1 data structures for trade item identification. A GTIN may be 8, 12, 13 or 14 digits long, and can be constructed using any of four numbering structures, depending upon the exact application. Although GTIN is referred to specifically in this disclosure as a standardized numbering structure suitable for the described application, the reference to GTIN is not intended to be exhaustive or limiting. Similarly, the supplier indication 205 may reflect or comply with a GLN recognized by GS1.

In the depicted embodiment, each entry 201 of IR 105 corresponds to the inventory of a particular supplier at a particular geographic location. Other embodiments of data table 201 may aggregate all items of inventory at a particular geographic location, regardless of supplier identity. Still other implementations of data table 201 may include fewer, more, and/or different columns of information. Moreover, although data table 201 representing IR 105 of FIG. 1 is shown in FIG. 2 as a flat file, other implementations employ a relational database (not shown) containing a plurality of tables. Regardless of the specific types of data or the format or architecture of the database, IR 105 as shown in FIG. 1 and FIG. 2 includes information indicative of the geographic distribution of the pooled inventory for at least one item.

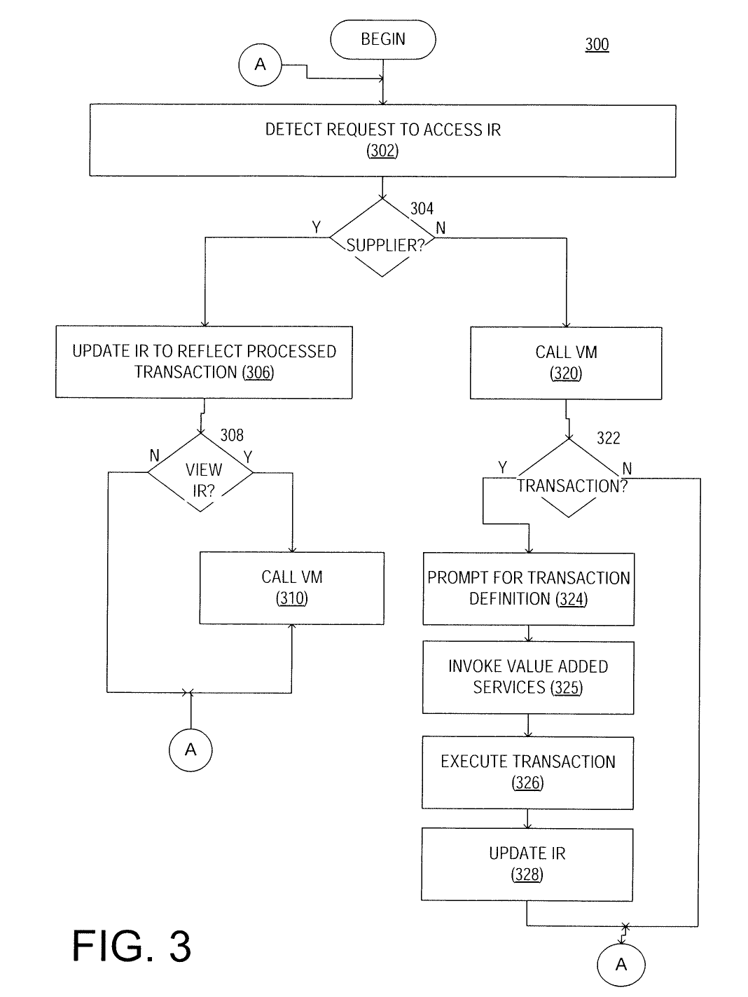

Returning to FIG. 1, the TM 102 as shown is operable to enable a remote user to execute an inventory transaction to alter the pooled inventory in IR 105. TM 102 may also be operable to modify or update IR 105 in response to an inventory transaction. TM 102 may be implemented as computer executable instructions stored or otherwise tangibly embedded in a computer readable medium. When executed, the instructions perform a method of executing an inventory transaction requested by a participant. An exemplary implementation of TM 102 is illustrated by the transaction method 300 depicted in FIG. 3. In the depicted implementation, transaction method 300 includes detecting (block 302) a request to access the IR 105. In response to detecting a transaction request, the method 300 as shown invokes (block 320) VM 104. VM 104, as described below, may provide a graphical or textual representation of the pooled inventory of an item. In embodiments suitable for applications involving geographically localized disruptions in the supply chain, for example, the viewing module may represent the pooled inventory in a manner that conveys the geographic distribution of the inventory, e.g., by superimposing bar graphs representing inventory on a map that includes the affected location(s) or region(s).

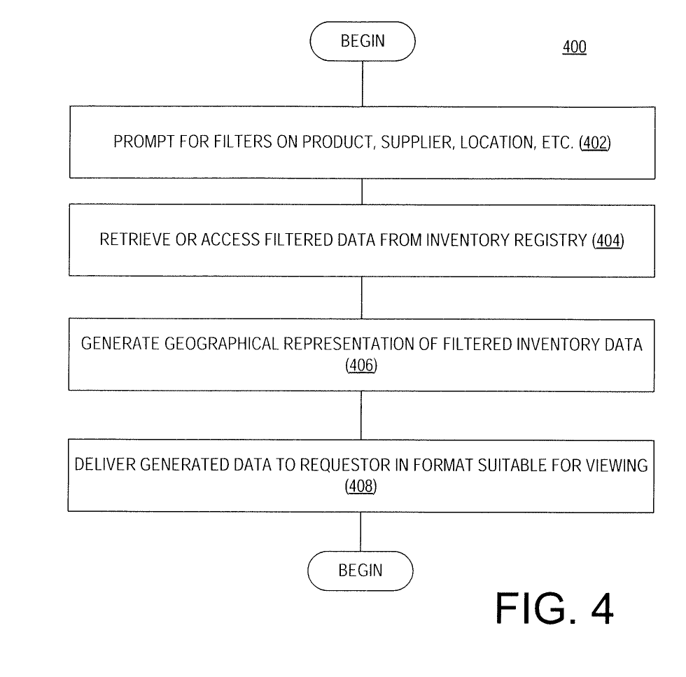

Referring to FIG. 4, a flow diagram conceptually illustrates the functionality of selected elements of an exemplary viewing module. As depicted in FIG. 4, VM 104 includes prompting (block 402) the user for any filters that the user might wish to apply to the database. Users may elect to view, for example, the inventory of just one product or one type of product. As another example, viewers may elect to view the inventory of a particular geographic location.

Following the definition of any applicable data filters, the depicted example of viewing module 104 retrieves or otherwise accesses (block 404) the requested data, as determined by the defined filters, from IR 105. The viewing module then generates (block 406) a geographical representation of the retrieved inventory information. The geographical representation enables a user to visualize the inventory distribution of one or more products or goods. The geographical representation, for example, might superimpose an indication of inventory levels, e.g., a bar over a map of a particular geographic region, e.g., a map of the United States to indicate visually the geographic distribution of inventory for a particular product. Viewing module 104 as shown in FIG. 4 then prepares and delivers (block 408) the information that is indicative of the geographic distribution of a particular product to the requester in a format that is suitable for being interpreted by the requesters browser 131 or other interface application.

Returning to FIG. 3, method 300 continues after invoking VM 104 by determining (block 322) whether the user wises to initiate or execute a transaction that affects the inventory of a particular product or item. If the user indicates affirmatively, the depicted embodiment of method 300 branches to block 324, where the user it prompts the user for information that is sufficient to define a transaction. The information sufficient to define a transaction is, to some extent, an implementation detail, but the user preferably indicates, at a minimum, a product description or standardized identifier, a quantity, and a delivery location. In other embodiments, the user may specify more parameters for the desired transaction including, as examples, the identity of a preferred supplier, an indication of a preferred originating location, and/or an indication of a preferred price.

After the user has provided information sufficient to define a transaction, the exemplified embodiment of method 300 may invoke (block 325) value added services including the value added services 160, depicted in FIG. 1, as being available to inventory manager 101. In some embodiments, the defined transaction, which might indicate little more than the product identifier, the quantity, and a destination, is made available, in block 325, to logistics service providers 140 and payment services providers 150 through value added services 160.

Value added services 160 as shown in FIG. 1 may provide services that pertain to the cost of the defined transaction and other items associated with the defined transaction. These other items may include which common carrier will transport the inventory, the mode of transportation, acceptable methods and terms of payment and so forth.. For example, the value added services as shown include a module 161 to support a bidding or auction model, a module 162 to engage in price negotiation, and a logistics module 165 to estimate the cost of shipping the product to the specified destination.

In the implementation as depicted in FIG. 1, value added services 160 are accessible to logistics service providers 140 and payment service providers 150 via network 110 and inventory manager 101. Logistics services providers 140 preferably include common carriers that are available to transport inventory from one location to another in response to a defined transaction. Similarly, payment service providers including banks, credit card issuers, credit card processing centers, and the like may interface with inventory manager 101 to facilitate payment of a specific transaction. Any or all of these value added services might be made available to users of inventory manager 101 as shown in FIG. 1.

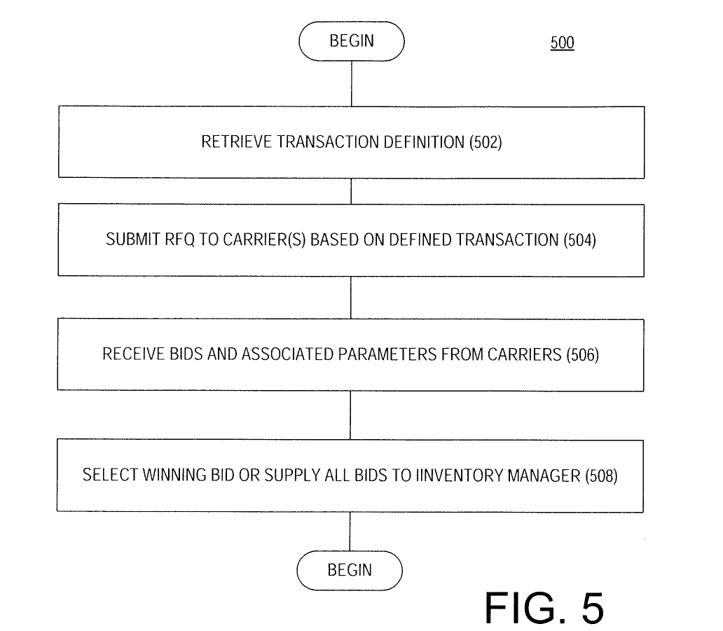

Logistics estimator 165, for example, may enable users to obtain shipping cost estimates from one or more common carriers, who would interact with logistics estimator 165 and bidding module 161 to submit bids or estimates for shipping inventory specified in a transaction from an origin to a destination. Referring to FIG. 5, exemplary functionality of an embodiment of a bidding module 161 is presented. In the depicted embodiment, bidding module 161 retrieves (block 502) the transaction as defined by a consumer or other. The applicable parameters are then extracted from the transaction definition by the bidding module and submitted or made accessible (block 504) to one or more common carriers. The submission of transactions to common carriers may be achieved using messages or other information that is in compliance with a defined API. The common carriers generate appropriate bids for the transaction and the bidding module then receives (block 506) the various bids back from the carriers. The bids may include, in addition to a price quote any exceptions to the transaction as requested including, for example, delivery date, quantity, etc. Bidding module 161 as shown in FIG. 5 may then either determine a winning bidder or, alternatively, submit all or some of the bids to inventory manager 101.

Returning to FIG. 3, in block 326, the transaction as defined by the consumer and any value added providers is executed. Transaction execution as represented in block 326 includes updating the contents of IR 105 to reflect changes in inventory represented by a particular transaction. In addition, transaction execution in block 326 may include automatically or electronically generating the business message or documents necessary to effect the transaction. Thus, for example, transaction execution in block 326 might include electronic transmission of purchase orders, advance shipment notices, and other business documents necessary to complete an order transaction. In addition, transaction execution might include informing a particular logistics provider 140 that its services have been selected and electronically initiating a shipping request.

In block 506, the depicted embodiment of logistics module 500 evaluates the common carrier quotes and selects a common carrier to execute the transaction. Criteria for selecting a quote is an implementation detail, but may include, in addition to the quoted price and delivery time, consideration of other factors, e.g., the carrier's historical reliability in meeting its quotes. After selecting a carrier, method 500 as shown includes initiating (block 508) the physical transport of the goods by submitting an transportation order to the selected carrier.

Returning now to FIG. 2, following the invocation of the logistics module in block 326, the depicted implementation of transaction module 300 updates the IR 105 to reflect the changes in inventory distribution resulting from execution of the inventory transaction. As depicted in FIG. 3, transaction module 300 is a looping application that jumps back to block 302 (detecting a request to access the inventory registry) following block 328. Similarly, for transactions initiated by a supplier, method 300 as shown jumps back to block 302 after executing block 310 or 308, depending on whether the user requested to view the inventory.

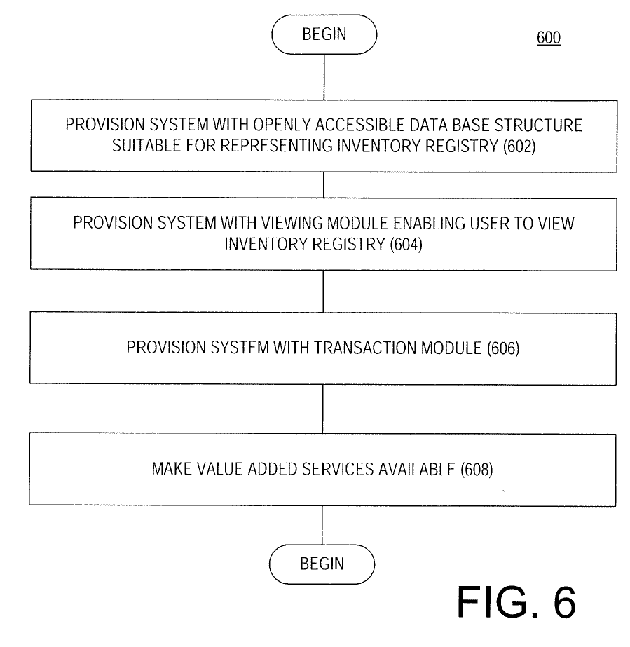

Also disclosed herein is a method of providing a service via which a data processing system is provisioned or otherwise enabled to include and support the inventory management functionality described herein. Referring to FIG. 6, a flow chart illustrates an embodiment of a method 600 for enabling a data processing system with inventory management functionality. In the depicted embodiment, method 600 includes provisioning a data processing system with inventory management functionality by provisioning the system with: a database structure suitable for representing IR 105 where the database structure is accessible to users including suppliers and consumers (block 602), an inventory viewing module (block 604) that enables a user to view the inventory registry data in a viewable format, and an inventory transaction module (block 606) and making (block 608) value added services, e.g., service 160 of FIG. 1, accessible to the system. In some embodiments, provisioning a data processing system with any or all of these elements is achieved by installing or otherwise providing access to computer executable instructions (software) that are stored on a computer readable medium.

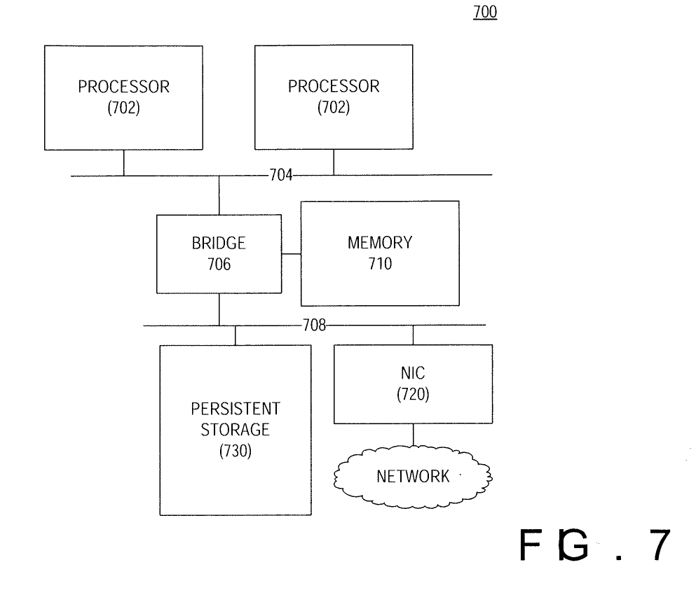

Some embodiments of the method support or require user registration as part of being able to access the inventory registry. Registration may include selective registration in which access to the registry is filtered according to one or more parameters. For example, in a situation where a first geographic location is experiencing a shortage of the item supplier access to the inventory registry may be limited to suppliers that are able to provide inventory to the first location and to consumers located at the first geographic location. In some embodiments, registration may be required to access inventory registry 105, but registration does not imply a fixed classification or relationship of the registrant with respect to inventory registry 105. In these embodiments, inventory manager 101 and inventory registry 105 support flexible interactions with users. Thus, for example, some embodiments may permit a user to execute consumer transactions during one session and supplier transactions during another. [0042] Referring now to FIG. 7, selected elements of a general computer system 700 suitable for implementing the and executing the inventory management functionality described herein are illustrated. In some embodiments, for example, all or substantially all of the functionality represented by inventory manager 101 as shown in FIG. 1 is implemented on a single general purpose computer 700. It should be appreciated, however, that a single server implementation is just one alternative. In other implementations, the functionality represented by FIG. 1 can be implemented in multiple servers systems connected by a wide area network across potentially large geographical sites.

As depicted in FIG. 7, data processing system 700 includes one or more general purpose microprocessors or central processing units (CPUs) 702 connected to a system bus 704. A bridge 706 provides and interface between system bus 704 and a peripheral bus 708 and a system memory 710. Peripheral devices including a network interface card (NIC) 720 and a persistent mass storage device (730) are shown as being connected to peripheral bus 708.

Processor(s) 702 may be implemented with x86 type processors including various processors from Intel, AMD, and others. Peripheral bus 708 is exemplified, for example, by a peripheral components interface (PCI) bus. Persistent storage 730 may be implemented with a conventional magnetic disk drive. Alternatively, mass storage may be provided to system 700 via networked storage including, as examples, a storage area network (SAN) or network attached storage (NAS). System 700 may further include input devices including keyboards, mouse, and so forth as well as output devices including a display terminal and one or more printers. Moreover, although system 700 in FIG. 7 and inventory manager 101 may be implemented with a single machine or computer, other embodiments encompass an inventory manager 101 that is implemented as a cluster or group of individual, but interconnect systems including server cluster implementations in which multiple individual processing boards are installed in a single chassis. In the embodiment depicted in FIG. 7, system 700 may store any or all of the elements 102 through 108 in persistent storage 730 and/or memory 710.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system X00 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing elements in which portions of a system, data structure, and/or software module are located on different physical devices that may be dispersed across a wide geographic region, component/object distributed processing, and parallel processing. Alternatively, virtual computer system processing can be constructed to implement one or more of the methods or functionality as described herein.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on one or more computer processors, which may be located on one or more geographically dispersed physical systems. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer implemented inventory manager, comprising:
an inventory registry containing information indicative of a pooled inventory of an item wherein the pooled inventory includes inventory of the item from two or more suppliers, wherein the registry is openly accessible to first and second suppliers of the item and to consumers of the item;
a viewing module operable to access the inventory registry and produce information indicative of the pooled inventory; and
a transaction module enabling a remote user to execute an inventory transaction to alter the pooled inventory indicated in the inventory registry.

2. The system of claim 1, wherein the item is selected from the set of critical items including medicine and bottled water.

3. The system of claim 1, wherein the inventory registry information includes a standardized identification of the item.

4. The system of claim 3, wherein the standardized identification comprises a global trade identification number (GTIN).

5. The system of claim 1, wherein the pooled inventory is suitable to convey a geographic distribution of the pooled inventory.

6. The system of claim 5, wherein the item is in critical shortage at a first geographic location and wherein the pooled inventory includes inventory at a second geographic location.

7. The system of claim 6, wherein the transaction module enables a consumer to initiate movement of at least some of the inventory at the second geographic location to the first geographic location.

8. A computer program product comprising instructions, stored on a computer readable medium, the instructions comprising:
instructions enabling multiple suppliers and multiple consumers of an item to access an inventory registry containing information indicative of a pooled inventory of the item, wherein the pooled inventory includes inventory of the item from two or more suppliers and wherein the inventory registry is indicative of a geographic distribution of the pooled inventory;
viewing module instructions to provide information enabling a user to visualize the geographic distribution of the pooled inventory;
transaction module instructions to enable the user to define and execute an inventory transaction altering the geographic distribution of the pooled inventory.

9. The computer program product of claim 8, wherein the item is selected from the set of critical items consisting of medicine and bottled water.

10. The computer program product of claim 8, wherein the inventory registry information includes a standardized identification of the item.

11. The computer program product of claim 10, wherein the standardized identification comprises a global trade identification number (GTIN).

12. The computer program product of claim 8, wherein the pooled inventory is suitable to convey inventory of the item at various geographic locations.

13. The computer program product of claim 12, wherein the item is in critical shortage at a first geographic location and wherein the pooled inventory includes inventory at a second geographic location.

14. The computer program product of claim 13, wherein the transaction module instructions enable a consumer to initiate movement of at least some of the inventory at the second geographic location to the first geographic location.

15. The computer program product of claim 8, wherein the transaction module instructions include instructions to invoke a value added service concerning a cost of the transaction.

16. The computer program product of claim 15, wherein the value added service comprises a logistics estimator enabling the user to obtain from one or more carriers an estimate of a shipping cost associated with the transaction.

17. A inventory management method, comprising:
provisioning a database structure accessible to multiple suppliers and multiple consumers of an item and indicative of a pooled inventory of the item, wherein the pooled inventory reflects inventory from multiple suppliers of the item and wherein the pooled inventory conveys a geographic distribution of the pooled inventory;
provisioning the system with a viewing module operable to interact with a user client to enable the user to visualize the geographic distribution of the pooled inventory; and
provisioning the system with a transaction module operable to being invoked by the user and further operable to enable the user to define and execute an inventory transacation that alters the geographic distribution of the pooled inventory by moving a portion of the pooled inventory to a first geopgrahic location from a second geographic location, wherein the transacation module is operable to modify the pooled inventory to reflect the alteration.

18. The method of claim 17, wherein the client user comprises a user's web browser.

19. The method of claim 17, wherein the viewing module is operable to enable the user to visualize the geopgraphic distribution graphically.

20. The method of claim 17, wherein the pooled inventory includes multiple entries, wherein an entry represents a portion of the pooled inventory, wherein the entry includes a standardized identifier of the item, an identification of a supplier of the corresponding pooled inventory portion, a quantity indication, and an indication of the geographic location of the corresponding pooled inventory potion.

21. The method of claim 17, wherein the transaction module is operable to enable a user to define a single transaction to transfer inventory located at a first geographic location to a second geographic location without regard to the identity or number of suppliers of the inventory at the first geographic location.

22. The method of claim 17, wherein provisioning the system with the database structure includes provisioning the system to permit a user to register with the system.

23. The method of claim 22, wherein provisioning the system with the database structure includes provisioning the system to permit any registered user to access the database.

24. The method of claim 22, wherein provisioning the system to permit a user to register with the system includes provisioning the system to permit the user to register with the system selectively.

25. The method of claim 24, wherein said first geographic location is experiencing a shortage of the item and wherein selective registration is based, at least in part, on the first geographic location.
